(19) United States
(12) Patent Application Publication
(10) Pub. No.: US 2009/0036245 A1
(43) Pub. Date: Feb. 5, 2009

(54) DOUBLE-SIDED ENGAGEMENT TYPE SILENT CHAIN

(75) Inventors: Toshitaka Ogo, Osaka (JP); Tomonori Yoshimura, Osaka (JP); Kenichi Nagao, Osaka (JP); Shouta Miyanaga, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 12/130,258

(22) Filed: May 30, 2008

(30) Foreign Application Priority Data
Aug. 3, 2007 (JP) 2007-203317

(51) Int. Cl. F16G 13/04

(52) U.S. Cl. 474/212

(57) ABSTRACT

In a double-sided engagement type silent chain in the form of an endless loop, the outermost link plates of the link rows whose outermost plates are not fixed to the chain's connecting pins, have teeth protruding toward the outside of the loon, and are paired in side-by-side relationship with adjacent inner link plates whose teeth protrude toward the inside of the loop.

### CROSS-REFERENCE TO RELATED APPLICATION

This application claims priority on the basis of Japanese patent application 2007-203317, filed Aug. 3, 2007. The disclosure of Japanese application 2007-203317 is hereby incorporated by reference.

### FIELD OF THE INVENTION

The invention relates to double-sided engagement type silent chains having outer link plates each having a pair of teeth which protrude outwardly from the outer circumferential side of the chain loop and inner link plates each having a pair of link teeth protruding inwardly from the inner circumferential side of the chain. The invention relates more specifically to an arrangement of link plates in a double-sided engagement type silent chain.

In this specification, the term “first link row” refers to a link row including link plates disposed on the outermost sides in the chain width direction, and to which connecting pins are fixed. The term “second link row” refers to the link rows, disposed alternately between successive first link rows, and which connect the successive first link rows to one another.

### BACKGROUND OF THE INVENTION

U.S. Patent Publication No. US2005/0277507 and U.S. Pat. No. 6,334,829 describe double-sided engagement type silent chains having outer link plates with pairs of teeth protruding outwardly, and inner link plates having teeth that protrude inwardly. An example of such chains is shown in FIGS. 3 and 4.

The conventional double-sided engagement type silent chain 1 includes first link rows L1, composed of outer link plates 2 and inner link plates 4′, and second link rows L2 composed of outer link plates 3 and inner link plates 5. The first and second link rows are disposed alternately along the length of the chain, with their link plates interleaved and connected in articulating relationship by connecting pins 6. The connecting pins are fixed to the outer plates 2.

As shown in FIG. 4, the outer link plates 2 and 3 and the inner link plates 4′ and 5 respectively have pairs of link teeth 2a, 3a, 4′a and 5a, pairs of pin holes 2b, 3b, 4′b and 5b, and flat back surfaces 2c, 3c, 4′c and 5c. Teeth 2a and 3a of the respective outer link plates 2 and 3 protrude outwardly, i.e., toward the outside of the loop in which the chain is formed, while the teeth 4′a and 5a of the inner link plates 4 and 5 protrude toward the inside of the loop.

When a tensile load acts in the longitudinal direction of the conventional double-sided engagement silent chain, flexion of the connecting pins allows significant elastic elongation of the chain. Therefore, when the chain is used as a timing chain in an engine, elastic elongation can allow phase shift in a cam sprocket, with a resulting erratic or deteriorated engine performance. Flexion of the connecting pins as a result of a tensile load also increases stress in the outer link plates 3 of the second links L2, reducing the overall fatigue strength of the chain.

The width of the conventional double-sided engagement silent chain also takes up a significant amount of space, which, in recent years, has become an increasingly important consideration in engine design.

Accordingly, objects of the invention include achieving one or more of the following advantages in a double-sided engagement type silent chain: reduction of elastic elongation, improvement of fatigue strength, and reduction of chain width.

### SUMMARY OF THE INVENTION

The chain according to the invention is an elongated, double-sided engagement silent chain in the form of an endless loop and having teeth protruding toward the outside of the loop as well as teeth protruding toward the inside of the loop. The chain comprises first and second widthwise rows of link plates, the rows being arranged in alternating relationship along the length of the chain.

The link plates of each second row are interleaved with link plates of each of two first rows, and the rows are connected in articulating relationship by connecting pins. Each link plate in the chain is formed with a pair of link teeth, a pair of pin holes, and a flat back surface.

Each first row comprises a pair of outer link plates in opposed relationship on opposite sides of the chain, and plural intermediate link plates disposed between its outer link plates. A pair of connecting pins is fixed to both outer link plates of each first row, and the teeth of the outer link plates of each first row protrude toward the outside of the loop, while the teeth of the intermediate link plates of each first row protrude toward the inside of the loop.

Each second row comprises a pair of outermost link plates and plural intermediate link plates. Each of the outermost link plates of each second row is disposed adjacent an outer link plates of each of two successive first rows. The teeth of the outermost link plates of each second row protrude toward the outside of the loop, and the teeth of the intermediate link plates of each second row protrude toward the inside of the loop. Each second row has one of its intermediate link plate positioned immediately adjacent each of its outermost link plates.

Among the advantages of the invention is that the elimination of certain of the inner plates allows the lengths of the connecting pins to be shortened. Consequently, when a tensile load acts on the chain, the flexion of the connecting pins is reduced, and the behavior of the outermost link plates of the second link rows is stabilized. Suppression of flexion of the connecting pins also reduces elastic elongation of the chain.

A further advantage is that the outermost link plates of the second link rows and their adjacent inner link plates function together as a single, thick, link plate capable of withstanding a large tensile load acting on the chain in the longitudinal direction. Thus stress in the outer link plates is reduced and the fatigue strength of the chain is improved.

The disposition of inner link plates of the first link rows on the inside in the chain width direction contributes to suppression of flexion of the connecting pins. Thus, tensile loads are distributed to other link plates, and stress of the outermost link plates of the second link rows is reduced.

Shortening of the connecting pins and the elimination of two of four inner link plates result in a reduction in the width of the chain, thereby achieving not only a space saving but also a weight reduction.

Increasing the thickness of the inner link plates so that they have the same thickness as inner link plates reduces elastic elongation of the chain while achieving a chain fatigue strength at least as high as that of the conventional double-sided engagement type silent chain, and also makes it possible to use the same plates throughout the chain, thereby reducing manufacturing costs.

### BRIEF DESCRIPTION OF THE DRAWINGS

FIG. 1 is plan view of a part of a double-sided engagement type silent chain according to the invention;

FIG. 2 is a side elevational view showing upper and lower parts of the chain of FIG. 1, arranged in an endless loop;

FIG. 3 is a plan view of a part of a conventional double-sided engagement type silent chain; and

FIG. 4 is a side elevational view showing upper and lower parts of the conventional chain of FIG. 3.

### DETAILED DESCRIPTION OF THE PREFERRED EMBODIMENTS

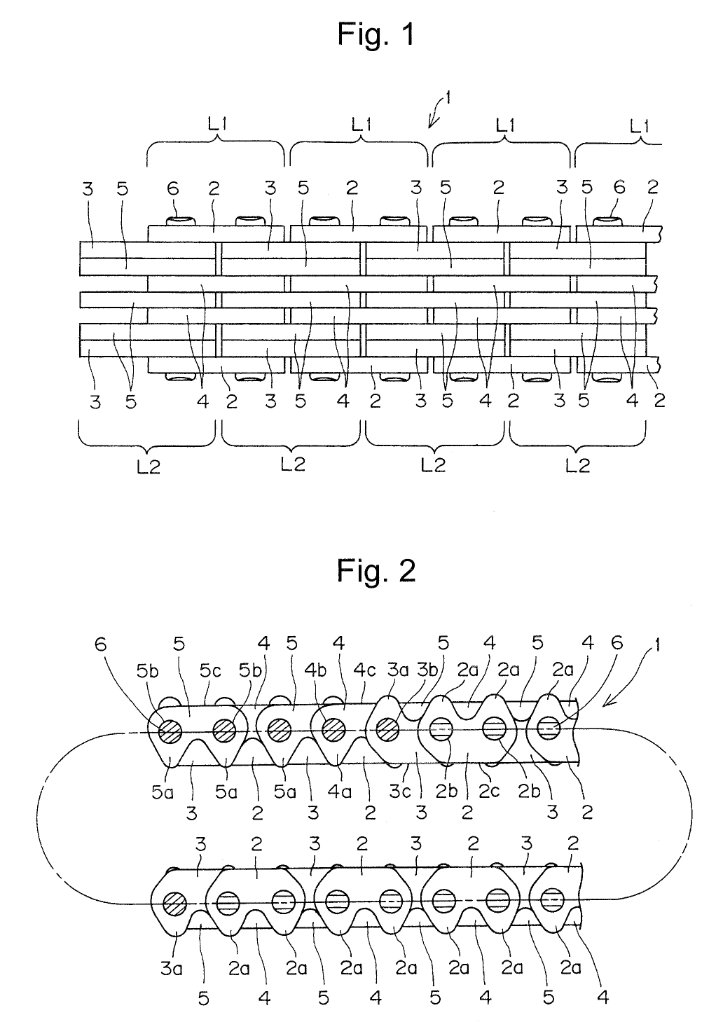

The double-sided engagement type silent chain 1, as shown in FIGS. 1 and 2, comprises first link rows L1 and second link rows L2 disposed in alternating relationship along the length of the chain with their plates in an interleaved relationship, forming an endless loop. Each first link row L1 is composed of a pair of outer link plates 2, and plural inner link plates 4. In the chain illustrated, each first link row comprises two inner link plates 4. Each second link row L2 is composed of a pair of outer link plates 3, which are the outermost link plates of the second row, and a plurality of inner link plates 5. In the second link rows L2, each outermost link plate 3 is in adjacent, side-by-side, relationship with an inner link plate 5, and preferably in contact with contact with the inner link plate 5.

The term “adjacent”, as used herein with reference to the relationship between link plates, means that the link plates are either in contact with each other, or in closely spaced relationship to each other with no other link plates between them.

As shown in FIG. 2, each of the link plates 2, 3, 4 and 5 has, respectively, a pair of teeth 2a, 3a, 4a and 5a, a pair of pin holes 2b, 3b, 4b and 5b, and a flat back surface 2c, 3c, 4c and 5c.

The link plates of the chain are interleaved in such a way that each link plate 4 of a first row L1 extends between a pair of link plates 5 of one second row L2 and between another pair of link plates 5 of a succeeding second row L2. Similarly, pairs of adjacent link plates 3 and 5 in each second row extend between a pair of link plates 2 and 4 of one first row, and between another pair of link plates 2 and 4 of a succeeding first row.

As shown in FIG. 2, teeth 2a of the outer link plates 2 in the first rows, and teeth 3a of the outermost link plates of the second rows, protrude toward the outside of the loop, while teeth 4a and 5a of the inner link plates 4 and 5 protrude toward the inside of the loop.

The link rows are held together in articulating relationship by connecting pins 6, which are fixed in the pin holes of the outer link plates 2, but fit loosely in the pin holes of the remaining link plates 3, 4 and 5.

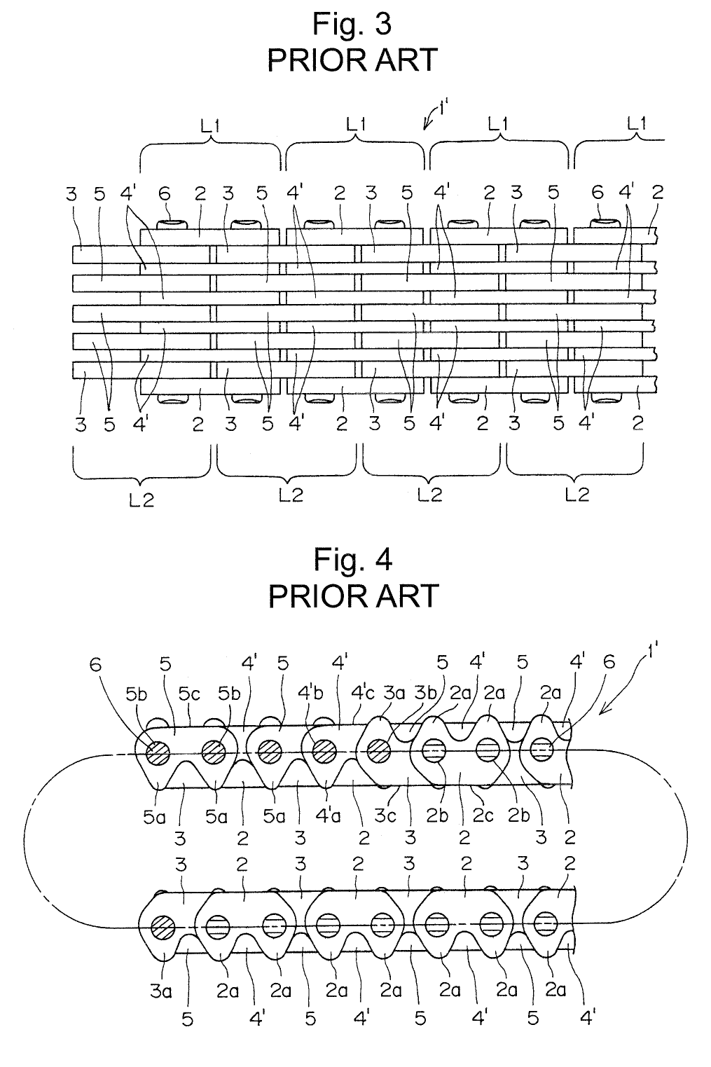

When the chain according to the invention, as illustrated in FIGS. 1 and 2, is compared with the conventional chain of FIGS. 3 and 4, it will be seen that plates 4′ extending between plates 3 and 5 are missing, so that plates 3 and 5 are in adjacent, side-by-side, relationship. Thus, the number of link plates in each first row L1 in the chain is less by two plates than the number of link plates in each first row L1 of the conventional chain. The teeth of plates 3 protrude outwardly, while the teeth of the adjacent link plates 5 protrude inwardly.

It will also be seen that plates 4 in the chain according to the invention are thicker than plates 4′ in the conventional chain. Their thickness is preferably equal to the thickness of link plates 5. Thus, although the number of the inner link plates in each of the first rows is reduced, good tensile strength of each first link is maintained by the increased thickness of the inner link plates in the first rows. Nevertheless, the lengths of the connecting pins are shortened due to the absence of two plates 4′ in each first row L1, and consequently, the flexion of the connecting pins 6 is made smaller for a given tensile load acting on the chain. As a result, the behavior of the outermost link plates 3 of the second link rows L2 is stabilized.

A further advantage of the chain structure according to the invention is that, because each outermost link plate 3 and its adjacent inner link plate 5 function together as a single, thick link plate capable of withstanding a large tensile load acting on the chain in the longitudinal direction, the fatigue strength of the chain is improved.

The disposition of inner link plates 4 of the first link rows L1 on the inside in the chain width direction, contributes to suppression of flexion of the connecting pins 6 when a tensile load acts in the longitudinal direction of the chain. The tensile load is distributed to other link plates, and stress of the outermost link plates 3 of the second link rows L2 is reduced. Furthermore, suppression of flexion of the connecting pins 6 reduces elastic elongation of the chain.

Shortening of the connecting pins 6 and the elimination of two of four inner link plates 4 result in a reduction in the width of the chain, thereby achieving not only a space saving but also a weight reduction.

Increasing the thickness of the inner link plates 4 so that they have the same thickness as inner link plates 5 reduces elastic elongation of the chain while achieving a chain fatigue strength at least as high as that of the conventional double-sided engagement type silent chain, and also makes it possible to use the same plates throughout the chain, thereby reducing manufacturing costs.

What is claimed is:

1. An elongated, double-sided engagement silent chain formed in an endless loop, the chain comprising first and second rows of link plates, the first and second rows being arranged in alternating relationship along the length of the chain, the link plates of each second row being interleaved with link plates of each of two first rows, and the rows being connected in articulating relationship by connecting pins, wherein:
each link plate in the chain is formed with a pair of link teeth, a pair of pin holes, and a flat back surface;
each first row comprises a pair of outer link plates in opposed relationship on opposite sides of the chain, and plural intermediate link plates disposed between said outer link plates, with a pair of connecting pins fixed to both outer link plates of each first row, the teeth of the outer link plates of each first row protruding toward the outside of the loop, and the teeth of said intermediate link plates of each first row protruding toward the inside of the loop;
each second row comprises a pair of outermost link plates and plural intermediate link plates, the outermost link plates of each second row being adjacent outer link plates of each of two successive first rows, the teeth of the outermost link plates of each second row protruding toward the outside of the loop, and the teeth of the intermediate link plates of each second row protruding toward the inside of the loop; and
each second row has one of its intermediate link plate positioned immediately adjacent each of its outermost link plates.
